(19) United States
(12) Patent Application Publication
(10) Pub. No.: US 2018/0077579 A1
(43) Pub. Date: Mar. 15, 2018

(54) SMALL CELL ACTIVATION IN HETNET

(71) Applicant: NOKIA SOLUTIONS AND NETWORKS MANAGEMENT INTERNATIONAL GMBH, Munich (DE)

(72) Inventor: Wolfgang ZIRWAS, Munich (DE)

(21) Appl. No.: 15/548,223

(22) PCT Filed: Feb. 27, 2015
(86) PCT No.: PCT/EP2015/054195

§ 371 Date: Aug. 2, 2017

(51) Int. Cl. H04W 16/06; H04W 16/32

(52) U.S. Cl. CPC H04W 16/06; H04W 84/045; H04W 16/32

(57) ABSTRACT

There is provided a method including, in a network that includes at least one larger cell and a plurality of smaller cells, determining a subset of the plurality of smaller cells in dependence on channel information associated with communication between a plurality of user equipments and at least one of the larger and smaller cells and activating the subset of smaller cells, wherein the activating includes causing the smaller cell to operate on resources associated with the at least one larger cell.

### FIELD

The present application relates to a method, apparatus, system and computer program and in particular but not exclusively, to joint transmission multi layer cooperation over macro and small cells.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

### SUMMARY OF THE INVENTION

In a first aspect there is provided a method comprising, in a network comprising at least one larger cell and a plurality of smaller cells, determining a subset of the plurality of smaller cells in dependence on channel information associated with communication between a plurality of user equipments and at least one of the larger and smaller cells and activating the subset of smaller cells, wherein activating comprises causing the smaller cell to operate on resources associated with the at least one larger cell.

The method may comprise determining at least one subframe or transmission time interval of the at least smaller cell and activating the at least one smaller cell for the at least one subframe or transmission time interval.

The method may comprise determining at least one resource block of the at least one first cell in dependence on channel information and activating the at least one first cell for the at least one resource block.

The method may comprise determining at least one smaller cell from the subset of smaller cells in dependence on channel information and applying a power boosting value for at least one resource block of the determined smaller cell.

The power boosting value may be selected from a plurality of boosting values.

The method may comprise controlling the number of at least one of resource blocks and transmission time intervals to which the power boosting value is applied in dependent of a transmission power limit.

The smaller cell may comprise a dual layer cell.

The channel information may comprise at least one of channel state information, path loss value information and user equipment context information.

The method may comprise controlling transmission of reference signals to the plurality of user equipments independently of the determination.

Activating the subset of smaller cells may comprise causing the subset of smaller cells to operate in a mode associated with the larger cells.

In a second aspect there is provided an apparatus, said apparatus comprising means for, in a network comprising at least one larger cell and a plurality of smaller cells, determining a subset of the plurality of smaller cells in dependence on channel information associated with communication between a plurality of user equipments and at least one of the larger and smaller cells and means for activating the subset of smaller cells, wherein activating comprises causing the smaller cell to operate on resources associated with the at least one larger cell.

The apparatus may comprise means for determining at least one subframe or transmission time interval of the at least smaller cell and activating the at least one smaller cell for the at least one subframe or transmission time interval.

The apparatus may comprise means for determining at least one resource block of the at least one first cell in dependence on channel information and means for activating the at least one first cell for the at least one resource block.

The apparatus may comprise means for determining at least one smaller cell from the subset of smaller cells in dependence on channel information and means for applying a power boosting value for at least one resource block of the determined smaller cell.

The power boosting value may be selected from a plurality of boosting values.

The apparatus may comprise means for controlling the number of at least one of resource blocks and transmission time intervals to which the power boosting value is applied in dependent of a transmission power limit.

The smaller cell may comprise a dual layer cell.

The channel information may comprise at least one of channel state information, path loss value information and user equipment context information.

The apparatus may comprise means for controlling transmission of reference signals to the plurality of user equipments independently of the determination.

Means for activating the subset of smaller cells comprises means for causing the subset of smaller cells to operate in a mode associated with the larger cells.

The apparatus may be a control unit of the network.

In a third aspect there is provided an apparatus said apparatus comprising at least one processor and at least one memory including computer program code, the at least one memory and the computer program code configured to, with the at least one processor, cause the apparatus at least to in a network comprising at least one larger cell and a plurality of smaller, determine a subset of the plurality of smaller cells in dependence on channel information associated with communication between a plurality of user equipments and at least one of the larger and smaller cells and activate the subset of smaller cells, wherein activating comprises causing the smaller cell to operate on resources associated with the at least one larger cell.

The apparatus may be configured to determine at least one subframe or transmission time interval of the at least smaller cell and activating the at least one smaller cell for the at least one subframe or transmission time interval.

The apparatus may be configured to determine at least one resource block of the at least one first cell in dependence on channel information and means for activating the at least one first cell for the at least one resource block.

The apparatus may be configured to determine at least one smaller cell from the subset of smaller cells in dependence on channel information and means for applying a power boosting value for at least one resource block of the determined smaller cell.

The power boosting value may be selected from a plurality of boosting values.

The apparatus may be configured to control the number of at least one of resource blocks and transmission time intervals to which the power boosting value is applied in dependent of a transmission power limit.

The smaller cell may comprise a dual layer cell.

The channel information may comprise at least one of channel state information, path loss value information and user equipment context information.

The apparatus may be configured to control transmission of reference signals to the plurality of user equipments independently of the determination.

The apparatus may be configured to cause the subset of smaller cells to operate in a mode associated with the larger cells.

The apparatus may be a control unit of the network.

In a fourth aspect there is provided a computer program embodied on a non-transitory computer-readable storage medium, the computer program comprising program code for controlling a process to execute a process, the process comprising, in a network comprising at least one larger cell and a plurality of smaller cells, determining a subset of the plurality of smaller cells in dependence on channel information associated with communication between a plurality of user equipments and at least one of the larger and smaller cells and activating the subset of smaller cells, wherein activating comprises causing the smaller cell to operate on resources associated with the at least one larger cell.

The process may comprise determining at least one subframe or transmission time interval of the at least smaller cell and activating the at least one smaller cell for the at least one subframe or transmission time interval.

The process may comprise determining at least one resource block of the at least one first cell in dependence on channel information and activating the at least one first cell for the at least one resource block.

The process may comprise determining at least one smaller cell from the subset of smaller cells in dependence on channel information and applying a power boosting value for at least one resource block of the determined smaller cell.

The power boosting value may be selected from a plurality of boosting values.

The process may comprise controlling the number of at least one of resource blocks and transmission time intervals to which the power boosting value is applied in dependent of a transmission power limit.

The smaller cell may comprise a dual layer cell.

The channel information may comprise at least one of channel state information, path loss value information and user equipment context information.

The process may comprise controlling transmission of reference signals to the plurality of user equipments independently of the determination.

Activating the subset of smaller cells may comprise causing the subset of smaller cells to operate in a mode associated with the larger cells.

In an fifth aspect there is provided a computer program product for a computer, comprising software code portions for performing the steps the method of the first and/or second aspects when said product is run on the computer.

In the above, many different embodiments have been described.

It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows a schematic diagram of an example cooperation area;

FIG. 4 shows a typical channel matrix in an example cooperation area;

FIG. 5 shows a flowchart of a method to be used in small cell integration;

FIG. 6 shows the results of a simulation of a method of an embodiment;

FIG. 7 shows an example of a control apparatus, according to an embodiment;

FIG. 8 shows a schematic diagram of an example apparatus;

### DETAILED DESCRIPTION

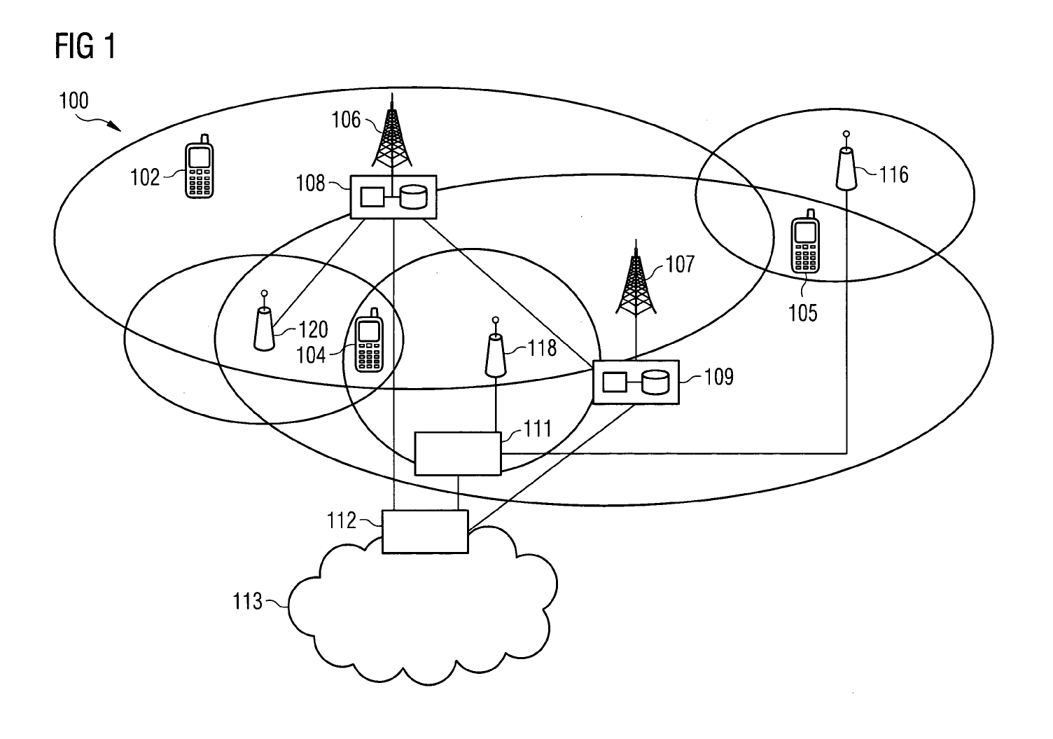

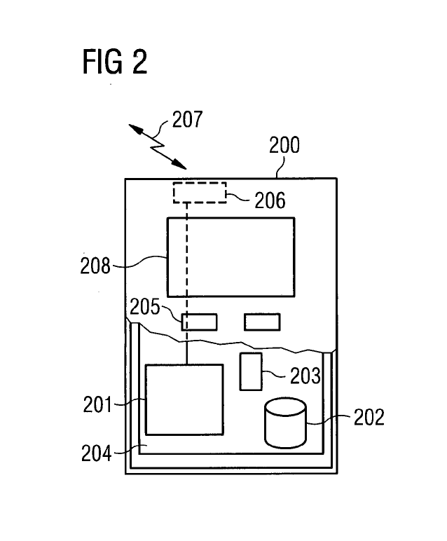

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller. The control apparatus may provide an apparatus such as that discussed in relation to FIG. 8.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

The embodiments are not, however, restricted to the system given as an example but a person skilled in the art may apply the solution to other communication systems provided with necessary properties.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

Another example of a suitable communications system is the 5G concept. Network architecture in 5G may be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent

The following relates to the future evolution of mobile radio systems going beyond LTE Advanced, i.e. so called 5G systems, with a focus on a tight (joint transmission) multi layer cooperation over macro and small cells. The following relates to the integration of small cells into cooperation areas formed by several macro cells

In the EU funded project Artist4G a so called interference mitigation framework (IMF-A) [Artist4G D1.3] has been developed and investigated providing for interference limited scenarios significant performance gains (e.g. more than 100%) under the assumption of perfect channel knowledge. IMF-A includes several techniques like joint transmission (JT) cooperative multipoint transmission (CoMP), interference floor shaping and specific user grouping and CoMP scheduling techniques.

In the current EU FP7 project METIS as well as in 3GPP, massive MIMO is seen as one of the main pillars for further performance gains. At the same time a denser deployment of cells is expected to cope with the expected future capacity demands. Such a deployment of cells, in METIS for example, may be known as ultra dense networks (UDN).

In METIS the goal is not only to rely on densification of cells, but also to maximize the spectral efficiency, especially for the lower GHz RF frequencies as being used today e.g. for LTE. In ARTIST4G the IMF-A framework achieves spectral efficiency gains by joint transmission cooperation over macro cells having 4×2 MIMO setups (similar to so called casel in 3GPP).

As limiting factors for further improvements two main issues had been identified, i.e. the limited channel rank for the collocated Tx-antennas per cell and signal to noise ratio (SNR) limitations, especially for indoor UEs. Beside massive MIMO, tight cooperation of macro and small cells may be helpful to overcome both limitations. Integration of small cells into the existing interference mitigation framework may increase coverage/SNR and overall channel rank per cooperation area.

Integration of small cells into macro cellular networks may pose several challenges. A fully tight integration of small and macro cells including powerful interference mitigation like joint transmission CoMP may be problematic.

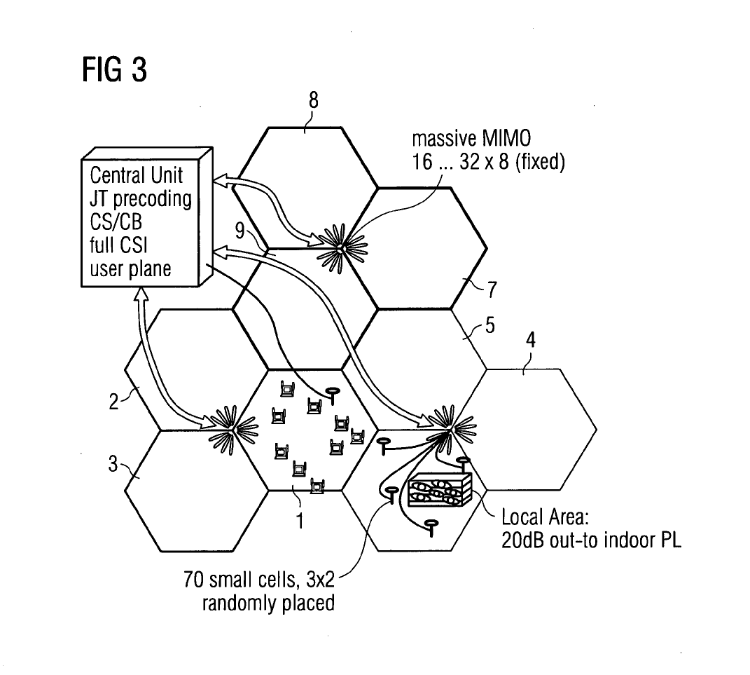

FIG. 3 illustrates a cooperation area of several macro cells, where each macro cell has an associated plurality of small cells with a tight connection (i.e. low latency high capacity backhaul) to the central unit controlling the cooperation area. The arrangement shown in FIG. 3 may be described as a network comprising at least one larger cell, i.e. macro cells, and a plurality of smaller cells. The plurality of smaller cells may at least partially overlap with the at least one larger cell, for example, the coverage area of a macro cell.

Macro cells may form a more or less homogeneous network allowing for a relatively ‘simple’ tight cooperation between adjacent cells and sites. For example in the IMF-A framework cooperation areas are formed by typically 3 sites or equivalently 9 cells. Tens to hundreds of small cells per macro cell may be provided for UDN networks, such that there are several hundreds of small cells per cooperation area. Reducing the size of the macro defined cooperation areas may lead to strong inter macro cell interference.

On the other hand tight cooperation over 3/9 macro sites/cells plus several hundreds of small cells may pose challenges as it requires corresponding channel estimation over several hundreds of radio stations, almost ideal backhaul connections to extremely large number of sites and cells carrying extremely large data rates. At the same time the according precoding matrix, which has to be processed at the central unit, will easily explode.

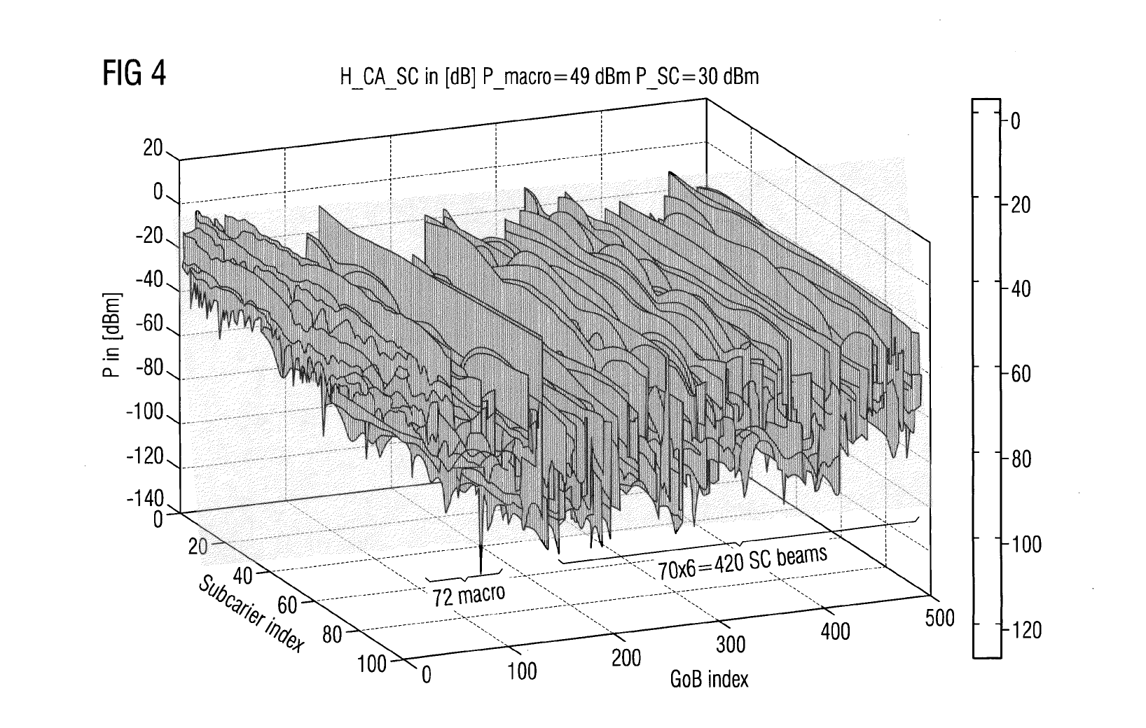

FIG. 4 shows a typical overall channel matrix in a fully activated—i.e. all small cells are on—cooperation area having 72 macro beams and 70×6 small cell beams. Different channel propagation conditions for macro and small cells and even more importantly the different maximum Tx powers may pose challenges. While macro cells are typically placed at high buildings with large coverage and due to high allocation have large Tx power of e.g. 49 dBm for a 20 MHz bandwidth, small cells will be typically placed below rooftop close to UEs and have to fulfil regulatory requirements like a limited Tx power with an equivalent isotropic RF power EIRP below 30 dBm. For that reason most UEs receive the macro radio stations with much larger power than the small cells, with exception of those few UEs being located extremely close to a small cell. As a result, the majority of UEs may select the macro station as serving cell. As a result the power normalization of the joint transmission precoder will typically significantly reduce the Tx power for the macro stations (for all UEs) with according SNR and data rate losses for all UEs.

Inter layer coupling between a limited number of macro cells and a high number of small cells may cause issues. Accordingly all macro and small cell UEs will be coupled together, i.e. will be connected by mutual interference so that any scheduling and precoding decision in one layer will affect the other layer. In addition the power imbalance between macro and small cell radio stations may make a tight cooperation as known for pure homogeneous macro networks difficult.

Multi layer networks—in 3GPP for example called HetNets—have been investigated for quite some time. One implementation of a multi-layer network is to use different frequency bands for small and macro cells, i.e. to provide full orthogonality between both layers, but this may affect efficiency.

Therefore co channel solutions have been proposed and investigated in 3GPP. Over the different releases more and more complex interference coordination schemes have been developed such as inter cell interference cancelation (ICIC), enhanced ICIC or further enhanced ICIC (feICIC), which means some form of coordination in time and/or frequency domain between active macro and active small cells. That way mutual interference may be controlled and avoided, but may be at the cost of a reduced number of resources available for macro cells and less importantly also for small cells.

For ICIC range extension is being used, which is not applicable for joint transmission CoMP schemes. Range extension, which is basically an early handover to small cells, has been proposed to address the power imbalance issue. For an early handover the handover is initiated to the small cell but the Rx power of the macro cell may still be higher than that for the small cell. This is possible as macro cells will be muted—or almost muted—on those resources where UEs are served by small cells.

It would be desirable to fully use the available resources in time and frequency. Furthermore overcoming or even exploiting interference as in tight joint transmission CoMP solution is sought.

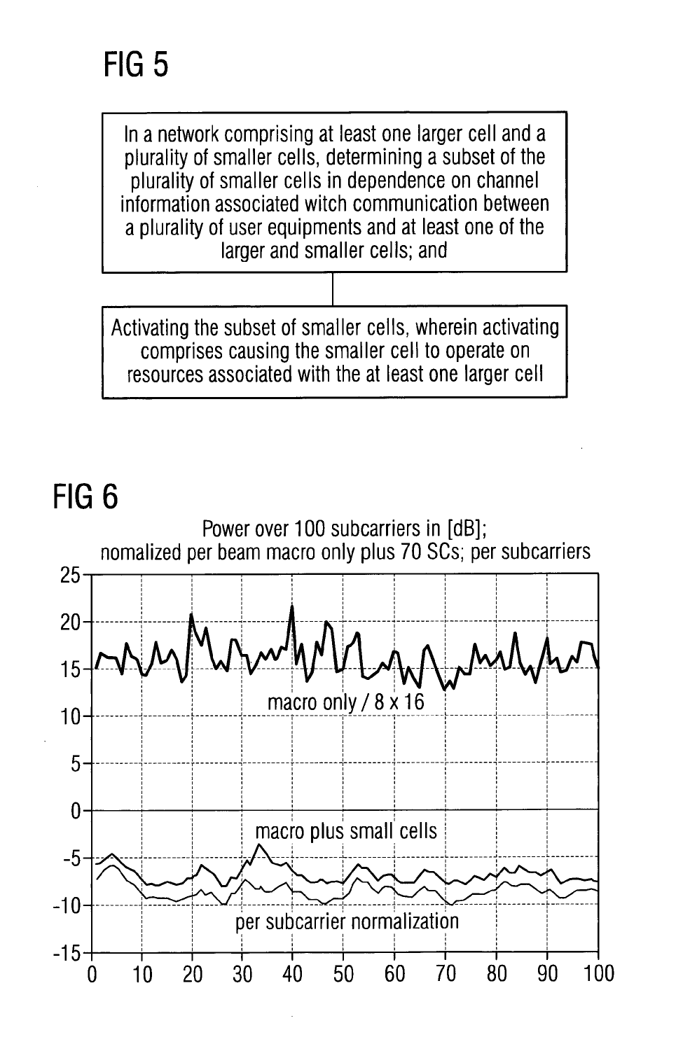

FIG. 5 shows a flow chart of a method for use in small cell integration. The method comprises, in a first step, in a network comprising at least one larger cell and a plurality of smaller cells, determining a subset of the plurality of smaller cells in dependence on channel information associated with communication between a plurality of user equipments and at least one of the larger and smaller cells and activating the subset of smaller cells, wherein activating comprises causing the smaller cell to operate on resources associated with the at least one larger cell. The smaller cell may be referred to as a small cell. The small cell may comprise a dual layer cell. The larger cell may be referred to as a macro cell. The network may comprise a cooperation area as described in relation to FIG. 3. The plurality of smaller cells may at least partially overlap with the at least one larger cell, for example, the coverage area of a macro cell.

The method may comprise determining at least one sub frame, transmission time interval (TTI) and/or physical resource block (PRB) of the at least one smaller cell in dependence on the channel information and activating the at least one smaller cell for the at least one subframe, TTI and/or PRB, respectively.

Small cell integration may use dual layer small cells, i.e. small cells which can be activated either in macro as well as small cell layer or at least can switch between macro and small cell layer, for example, per TTI. That way the small cell frequency band may be used for classical data offloading substantially independent of the macro layer.

A subset of all small cells within the macro layer may be activated in an opportunistic way, i.e. only those small cells which provide a benefit to the macro layer or for UEs in the general vicinity of the small cells. The proposed method may provide optimum performance for all served and actually scheduled UEs of the cooperation area.

In one embodiment, the method comprises opportunistic activation of selected subsets of dual layer small cells from the pool of all available small cells depending on benefits for the macro layer UEs with respect to SNR/coverage and rank of the channel matrix. This may done per subframe or TTI and per PRB depending on scheduling decisions of the central unit. The variation over PRBs is due to the potentially different served sets of UEs on different PRBs.

In one embodiment, a central unit controlling the cooperation area may decide which PRBs of which small cells should be activated for which set of users. In one embodiment, a central unit controlling the cooperation area may decide on a subframe or TTI basis about the small cells which should participate on what resources—e.g. physical resource blocks (PRB).

In one embodiment, a small cell might be a single RF version limited to the macro layer. In that case, deactivated small cells might be switched off completely in contrast to dual layer small cells, which would be still active in the small cell layer. If the small cells have only one fixed RF band, i.e. the macro RF band, the small cells may be switched on and off.

Activating the at least one smaller cell may comprise causing the subset of smaller cells to operate in a mode associated with larger cells, i.e. in the macro layer. Activating the at least one first cell may comprise providing an indication of the determination in a message, for example over an X2 interface. In one example, small cells may be switched off depending on whether there are UEs to be served or not. This may improve energy efficiency. In the case of opportunistic activation only the selected subset of small cells may be allowed to transmit and all other small cells have to be quiet to avoid any unwanted interference. Only if a small cell—for example an indoor small cell—is fully orthogonal to the other UEs may it be allowed to individually schedule users. This leads for the small cells to following possible modes typically decided by the central unit and controlled by according mode messages send for example over the X2 interface:
a) Inactive: such small cells are not allowed to transmit (possibly confined to special subset of PRBs)
b) Integrated CoMP mode: participate at JT CoMP transmission
c) Orthogonal: independent scheduling allowed potentially with accordingly power limits to certain PRBs (it is assumed that such small cells are sufficiently orthogonal to other UEs and does not interfere)
d) ICIC: use interference coordination as for example defined for LTE instead of tight cooperation. This might be limited to certain subset of PRBs.

As an example, in the case of low load no small cells might be activated or, alternatively, some of the 3GPP ICIC schemes might be used. With increasing number of UEs and accordingly the need for higher rank of the overall channel matrix and increasing inter cell interference the best fitting subset of small cells will be activated. This proposal optimises the usage of small cells and avoids increased overhead e.g. on the backhaul link, the calculation of the CoMP precoder, estimation and reporting of channel state information etc. This may be applicable over a large number of available small cells.

Even for well selected small cells there may be a power imbalance issue which may reduce precoding performance.

The method may comprise determining at least one smaller cell from the subset of smaller cells in dependence on channel information and applying a power boosting value for at least one determined smaller cell. Power boosting is proposed for small cells with relatively low Rx power compared to that of the macro cells. Power boosting is possible—despite the maximum Tx power limit—in the case where only a subset of resources (PRB) of a small cell are active at a time. In that case the maximum EIRP limit of e.g. 30 dB Tx power per small cell may be maintained despite the power boosting on a certain subset of resources. As in macro cells where typically many UEs will have to be served, the scheduler can ensure that different small cells are activated on different PRBs, at least in case power boosting is needed.

The power boosting value may be adapted depending on the overall channel conditions for the simultaneously served UEs and will therefore change from PRB to PRB and time slot to time slot. The method may comprise adaptation of power boosting value of small cells on PRBs calculated at the central scheduling unit together with a limitation on the maximum allowed number of PRBs and/or time slots for that small cell. The limitation of used resources avoids any violation of the regulatory maximum Tx-power limit.

For single link transmission such a fast varying power boosting on user data may lead to a challenge for the receiver due to varying Rx power, making any higher QAM constellation decoding more or less impossible. In case of Joint transmission CoMP it is a multilink transmission and power boosting on one link—or for one radio station—will be properly corrected by the transmit signals from other radio stations. Therefore there is no need to inform UEs about the used Tx power boosting value.

In alternative versions the power boosting value might be selected from a limited set of boosting values to minimize the overhead for control information between central unit and small cell scheduler.

In one case power boosting might be just switched on or off, e.g. based on a predefined threshold. In one embodiment, small cell power boosting may be implemented in the following way: UEs report their path loss as well as their CSI RS values similarly as before. A power boosting of e.g. 10 dB for a specific small cell means then that the central unit assumes for the precoder calculation for that cell a 10 dB lower than reported path loss value (or equivalently 10 dB higher than reported received Rx power). The calculated precoding weights for that small cell have than to be transmitted from the small cell with accordingly higher Tx-power so that the UEs are receiving the signal with the expected power. For that purpose the central unit sends an according power boosting control message to the small cells.

Power boosting values may be calculated from power maps. Note the overall concept is very robust against few dB varying power boosting values so that also relatively inaccurate power maps can be used.

For homogenous macro cells the so called ‘tortoise’ interference floor shaping technique is been used to minimize inter cooperation area interference. Maximum power boosting values might be defined based on the locations of the small cells. By setting lower limits to small cells at the border of the cooperation area the interference floor into adjacent cooperation areas can be reduced. Power maps may be used to have a finer granular adaption of power boosting values.

Channel information may comprise channel state information, path loss value information and user equipment context information. Channel state information (CSI), for example, path loss values from UEs to small cells should be known. The path loss values may be accumulated semi statically so that the according overhead will be relatively small. Alternatively one might use context awareness about the location, Tx power, power map of small cells together with location information provided by UEs to decide about the best fitting small cells for serving a certain set of UEs and on according power boosting values.

One way to estimate path loss values from UEs to small cells would be by semi static reference signal received power (RSRP) measurements to all potential small cells. As correlation distances for large scale parameters are quite large the according overhead for measurements can be expected to be small.

Alternatively context awareness about small cell and UE locations together with some more or less accurate power maps per radio station could activate the best fitting small cells from all available ones without any path loss measurements (see above).

Based on the decision of the central unit, UEs may report on their relevant channel components estimated from according small cell individual RSs. Transmission of reference signals to the plurality of user equipments may be controlled independently of the determination. For example, in one embodiment, to allow for accurate channel estimation and/or channel prediction as one main enabler for JT CoMP channel state information (CSI) reference signal (RS) transmission has to be switched on either constantly or at least early enough before according UEs might be scheduled. An independent on/off of CSI RSs and of data transmissions may be controlled by the central unit.

A combination of massive MIMO (grid of beam concept) per macro cell together with opportunistic small cell activation and power boosting may provide mutual benefits. For example with massive MIMO the power imbalance problem is less severe compared to conventional e.g. 4×2 MIMO.

One benefit of the concept is that it makes a tight cooperation of small and macro cells feasible even for extremely large number of small cells. The resulting interference mitigation, rank enhancement and SNR gains may lead to significantly improved spectral efficiency and coverage.

Opportunistic activation of a limited subset of small cells instead of potentially extremely large numbers of small cells ensures that the overall complexity of the system is limited. This affects the complexity for backhaul, channel estimation as well as reporting, precoder calculation, etc. Selecting the best fitting small cells from a large set of potential small cells ensures similar performance as achievable in case all small cells would be active at the same time.

Significant performance gains may be possible. FIG. 6 shows the results of a simulation showing power normalization loss (PNL)—being the sum power of all precoding weights for zero forcing—to show the benefit for cooperation over macro plus small cells. Ideally the PNL should be close to zero or even better below zero dB. The PNL is for 80 simultaneously served UEs per cooperation area comprising 3 sites equal to 9 cells, i.e. about 9 simultaneously served UEs per macro cell. As can be seen in FIG. 6, activation of 20% of overall 400 small cell beams provided significant gain over macro only performance and was quite close to that of full activation of all 400 small cell beams.

Fast adaptation of power boosting on per PRB basis overcomes the otherwise severe limitations on the precoder performance due to power imbalance between macro and small cells.

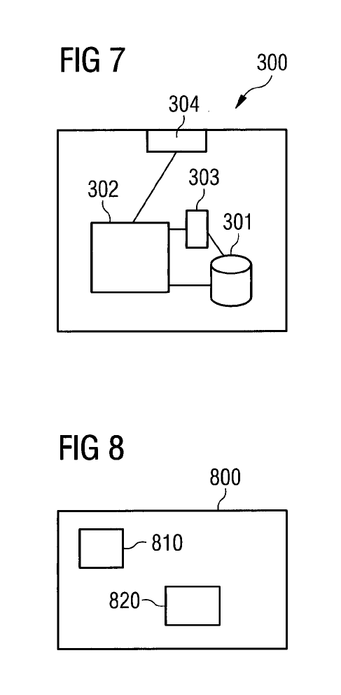

Embodiments described above by means of FIGS. 1 to 6 may be implemented on an apparatus, such as a node, host or server, or in a unit, module, etc. providing control functions as shown in FIG. 7 or on a mobile device (or in a unit, module etc. in the mobile device) such as that of FIG. 2. FIG. 7 shows an example of such an apparatus. In some embodiments, a base station comprises a separate unit or module for carrying out control functions. In other embodiments, the control functions may be provided by another network element such as a radio network controller or a spectrum controller. The apparatus may be the central unit as described in relation to FIG. 3. The apparatus 300 may be arranged to provide control on communications in the service area of the system. The apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the apparatus 300 may be configured to execute an appropriate software code to provide the control functions. Control functions may include at least in a network comprising at least one larger cell and a plurality of smaller cells, determining a subset of the plurality of smaller cells in dependence on channel information associated with communication between a plurality of user equipments and at least one of the larger and smaller cells and activating the subset of smaller cells, wherein activating comprises causing the smaller cell to operate on resources associated with the at least one larger cell.

An example of an apparatus 800, as shown in FIG. 8 may comprise means 810 for, in a network comprising at least one larger cell and a plurality of smaller cells, determining a subset of the plurality of smaller cells in dependence on channel information associated with communication between a plurality of user equipments and at least one of the larger and smaller cells and means 820 for activating the subset of smaller cells, wherein activating comprises causing the smaller cell to operate on resources associated with the at least one larger cell.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to 5G, similar principles can be applied to any other communication system or radio access technology.

Embodiments are generally applicable multilayer cooperation is supported. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments as described above by means of FIGS. 1 to 6 may be implemented by computer software executable by a data processor, at least one data processing unit or process of a device, such as a base station, e.g. eNB, or a UE, in, e.g., the processor entity, or by hardware, or by a combination of software and hardware. Computer software or program, also called program product, including software routines, applets and/or macros, may be stored in any apparatus-readable data storage medium or distribution medium and they include program instructions to perform particular tasks. An apparatus-readable data storage medium or distribution medium may be a non-transitory medium. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments described above in relation to FIGS. 1 to 6 may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
in a network comprising at least one larger cell and a plurality of smaller cells, determining a subset of the plurality of smaller cells in dependence on channel information associated with communication between a plurality of user equipments and at least one of the larger and smaller cells; and
activating the subset of smaller cells, wherein activating comprises causing the smaller cell to operate on resources associated with the at least one larger cell.

2. A method according to claim 1, comprising:
determining at least one subframe or transmission time interval of the at least smaller cell; and
activating the at least one smaller cell for the at least one subframe or transmission time interval.

3. A method according to claim 1, comprising:
determining at least one resource block of the at least one first cell in dependence on channel information; and
activating the at least one first cell for the at least one resource block.

4. A method according to claim 1, comprising:
determining at least one smaller cell from the subset of smaller cells in dependence on channel information; and
applying a power boosting value for at least one resource block of the determined smaller cell.

5. A method according to claim 4, wherein the power boosting value is selected from a plurality of boosting values.

6. A method according to claim 4, comprising controlling the number of at least one of resource blocks and transmission time intervals to which the power boosting value is applied in dependent of a transmission power limit.

7. A method according to claim 1, wherein the smaller cell comprises a dual layer cell.

8. A method according to claim 1, wherein the channel information comprises at least one of channel state information, path loss value information and user equipment context information.

9. A method according to claim 1, comprising controlling transmission of reference signals to the plurality of user equipments independently of the determination.

10. A method according to claim 1, wherein activating the subset of smaller cells comprises causing the subset of smaller cells to operate in a mode associated with the larger cells.

11. A method according to claim 10, wherein the mode comprises one of active mode, inactive mode, integrated coordinated multipoint mode, orthogonal mode and inter-cell interference coordination.

12. (canceled)

13. A computer program product for a computer, comprising software code portions for performing the steps of claim 1 when said product is run on the computer.

14. An apparatus comprising:
at least one processor;
and at least one memory including computer program code;
the at least one memory and the computer program code configured to, with the at least one processor, cause the apparatus at least to:
in a network comprising at least one larger cell and a plurality of smaller cells, determine a subset of the plurality of smaller cells in dependence on channel information associated with communication between a plurality of user equipments and at least one of the larger and smaller cells; and
activate the subset of smaller cells, wherein activating comprises causing the smaller cell to operate on resources associated with the at least one larger cell.
